(19) United States
(12) Patent Application Publication
(10) Pub. No.: US 2006/0155625 A1
(43) Pub. Date: Jul. 13, 2006

(54) Method for financing of long-term energy acquisition

(76) Inventors: Steven Bunkin, New York, NY (US); Karim Manji, Calgary (CA); John M. Tully, Hoboken, NJ (US); Arthur M. Miller, New York, NY (US); Simon Collier, Brooklyn, NY (US)

Correspondence Address: BUCKLEY, MASCHOFF, TALWALKAR LLC, 5 ELM STREET, NEW CANAAN, CT, 06840, US

(21) Appl. No.: 11/265,640

(22) Filed: Nov. 2, 2005

Related U.S. Application Data
(60) Provisional application No. 60/627,540, filed on Nov. 12, 2004.

(51) Int. Cl. G06Q 40/00

(52) U.S. Cl. 705/35

(57) ABSTRACT

According to some embodiments, a method includes establishing a special purpose entity in which a first party has made an equity investment. The method further includes establishing a first sales agreement between the special purpose entity and a second party for the special purpose entity to supply a physical commodity to the second party. The method further includes applying a prepayment amount received under the first sales agreement to acquire a guaranteed investment contract from an insurance company. The method further includes establishing a second sales agreement between the special purpose entity and a supplier for the supplier to supply the physical commodity to the special purpose entity.

### CROSS-REFERENCE TO RELATED APPLICATION

This application claims benefit from provisional patent application No. 60/627,540, filed Nov. 12, 2004, which is incorporated herein by reference.

### FIELD

The present invention relates to municipal finance. In some embodiments, the present invention relates to methods for financing long-term energy purchases by municipal utility companies.

### BACKGROUND

Long-term prepaid energy purchases by municipalities and/or municipal energy utilities present opportunities for interest rate arbitrage, since such purchases may be financed by relatively low-interest-rate tax-exempt borrowing on the part of the municipality and may accrue the benefit of (higher) discounting rates, which reflect interest rates accrued by taxable markets, when the present value of future energy deliveries is taken into account. However, lump-sum prepayment to a prospective long-term energy supplier may entail substantial credit risk and adverse accounting implications.

### SUMMARY

In light of the foregoing, embodiments of the present invention concern a method to establish a special purpose entity in which a first party has made an equity investment, to establish a first sales agreement between the special purpose entity and a second party for the special purpose entity to supply a physical commodity to the second party, to apply a prepayment amount received under the first sales agreement to acquire a guaranteed investment contract from an insurance company, and to establish a second sales agreement between the special purpose entity and a supplier for the supplier to supply the physical commodity to the special purpose entity.

In some aspects, the second party may enter into an interest rate swap transaction to pay a fixed rate and to receive a variable rate payment. In some aspects, a first commodity swap transaction may be established between the special purpose entity and a third party for the special purpose entity to pay to the third party a fixed price for the physical commodity and for the special purpose entity to receive from the third party an index price for the physical commodity. The second party may enter into a second commodity swap transaction with the third party for the third party to pay to the second party the fixed price for the physical commodity and for the second party to pay to the third party the index price for the physical commodity. The equity investment by the first party in the special purpose entity may be a contingent investment such as a contingent funding agreement. The physical commodity may be natural gas or electricity.

In another aspect, a method of achieving interest-rate arbitrage with reduced exposure to credit risks includes a municipal entity issuing tax-exempt bonds to fund a prepayment, where the bonds have a maturity period. The method further includes transferring the prepayment to a special purpose entity in return for the special purpose entity's obligation to provide natural gas or electricity to the municipal entity over a fixed term that matches the maturity period of the bonds. The method further includes the special purpose entity using the prepayment to obtain a guaranteed investment contract from an insurance company, where the guaranteed investment contract has a contract term that matches the fixed term and the guaranteed investment contract provides a fixed return funding flow to the special purpose entity during the contract term. The method further includes the special purpose entity entering into a supply agreement with a supplier to make periodic payments to the supplier in return for the supplier supplying fixed quantities of natural gas or electricity to the special purpose entity during a supply agreement term that matches the contract term.

As used herein and in the appended claims a “municipal entity” refers to any of the 50 states of the United States or of any territory or district of the United States or any entity that is or is controlled by a subdivision of an agency of a state, territory or district of the United States.

In another aspect, a method includes establishing a special purpose entity, receiving a prepayment from a municipal entity, obligating the special purpose entity to supply natural gas or electricity to the municipal entity, investing the prepayment to obtain a fixed return, and entering the special purpose entity into an agreement with a supplier to obtain a fixed supply of natural gas or electricity.

Thus, in some aspects, the obligations of the special purpose entity to the municipality are supported by a very low risk investment such as a guaranteed investment contract issued by a highly rated insurance company, and the municipality is insulated from a large part or all of any credit risk involved in dealing with the energy supplier which is the source of supply under contract to the special purpose entity.

In another aspect, no part of the prepayment is treated as debt of the first party for balance sheet and accounting purposes.

With these and other advantages and features of the invention that will become hereinafter apparent, the invention may be more clearly understood by reference to the following detailed description of the invention, the appended claims, and the drawings attached hereto.

### BRIEF DESCRIPTION OF THE DRAWINGS

FIG. 1 is a schematic illustration of a financing technique provided according to some embodiments.

FIG. 2 is a flow chart that illustrates a process performed in accordance with the financing technique of FIG. 1.

### DETAILED DESCRIPTION

In general, and for the purposes of introducing concepts of embodiments of the present invention, a special purpose entity is inserted between a municipal agency and a supplier of energy under a long-term financing arrangement. The special purpose entity receives from the municipal entity a prepayment for an energy supply and invests the prepayment in a guaranteed investment contract issued by a highly rated insurance company. The special purpose entity contracts with an energy supplier (supplier of natural gas or electricity) for a supply of energy on a long-term basis. The supply contract is to be financed by funds provided from the guaranteed investment contract. The municipal entity is largely or entirely sheltered by the special purpose entity and the guaranteed investment contract from any risks arising from potential failure of the energy supplier.

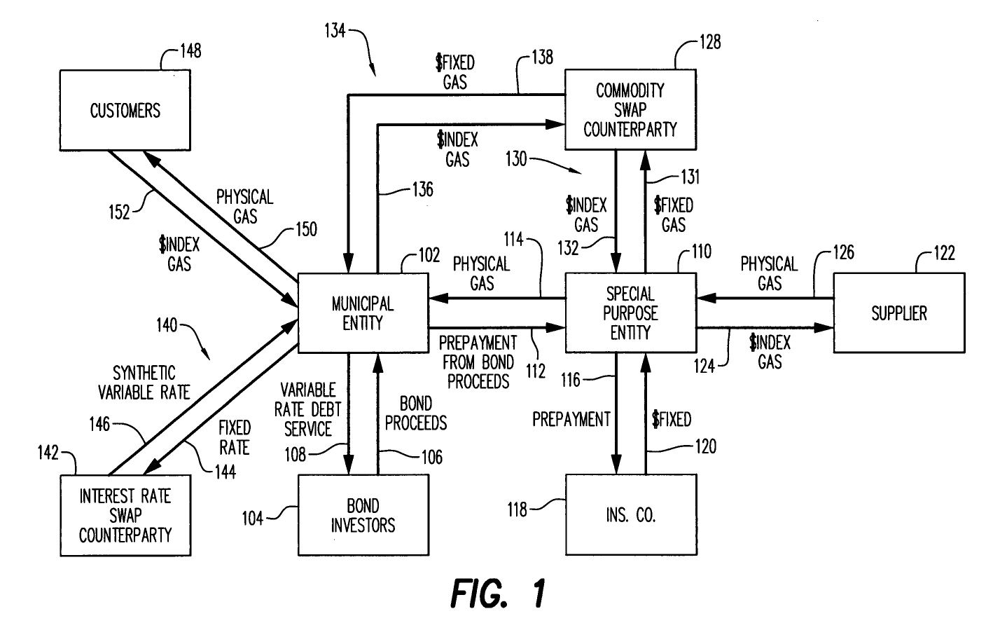

Features of some embodiments of the present invention will now be described by first referring to FIG. 1. FIG. 1 is a diagram that illustrates a sequence of transactions involved, in accordance with the invention, in financing a long-term energy supply arrangement for the benefit of a municipal entity. As illustrated in FIG. 1, a municipal entity 102 (e.g., a municipally-owned gas and/or electric utility) issues tax-exempt bonds to bond investors 104. Net proceeds of the bond issue, as indicated at 106, are received by the municipal entity 102. The bonds may pay interest at a rate that varies according to market conditions, in some embodiments. The municipal entity 102 is obligated to provide debt service for the bond issues over the life of the bonds, as indicated at 108.

A special purpose entity 110 is established especially for purposes of the financing arrangement indicated in FIG. 1. In some embodiments, an entity (not necessarily shown in the drawing) independent of the municipal entity 102 holds an equity interest in the special purpose entity 110. The equity investment in the special purpose entity 110 may be in the form of a contingent funding agreement. To support equity ownership for tax purposes of the special purpose entity 110 independent of the municipal entity 102, the contingent funding agreement may be in an amount that corresponds to 3% or more of the assets of the special purpose entity 110.

The special purpose entity 110 and the municipal entity 102 enter into a transaction in which the municipal entity 102 makes a prepayment 112 (funded by the bond proceeds 106) to the special purpose entity 110. In return, the special purpose entity 110 is obligated to provide a supply of energy (in this instance, in the form of natural gas 114; may alternatively be in the form of electricity) to the municipal entity 102 on a long-term basis (e.g., over a period matching the term of the bonds, such as 10 to 20 years).

The special purpose entity 110 may invest the prepayment 112 (as indicated at 116) in a guaranteed investment contract issued by a highly-rated (e.g., AA to AAA) insurance company 118. The guaranteed investment contract may provide a return at a fixed rate that corresponds to a return for taxable investments. The fixed funding flow to be provided to the special purpose entity 110 by the guaranteed investment contract is indicated at 120. The term of the guaranteed investment contract may be the same as that of the bonds issued by the municipal entity 102 and of the contract between the municipal entity 102 and the special purpose entity 110.

The funding flow 120 at least indirectly supports a long-term supply contract entered into by the special purpose entity 110 with an energy supplier 122. According to that supply contract, the special purpose entity agrees to make payments (indicated at 124) indexed to the price, from time to time, or at a fixed price of the energy to be supplied, in return for a commitment from the supplier 122 to provide energy (in this instance in the form of natural gas 126) to the special purpose entity 110. The gas supplied by the supplier 122 may be passed through the special purpose entity 110 to the municipal entity 102 to satisfy the special purpose entity's supply obligation 114. The payments to the supplier are expected to be made from the cash flow received by the special purpose entity from the guaranteed investment contract.

Two commodity swap transactions may be arranged with a commodity swap counterparty 128 to allow the municipal entity 102 to effectively pay current (indexed) prices for the energy over the course of the financing/supply arrangement. The commodity swap counterparty 128 may be independent of the municipal entity 102 and the special purpose entity 110. In the first commodity swap transaction (indicated at 130), which is between the special purpose entity 110 and the commodity swap counterparty 128, the special purpose entity 110 effectively agrees to pay to the commodity swap counterparty 128 a fixed price 131 for the gas supplied by the supplier 122 and to receive from the commodity swap counterparty an index price 132 for the gas. In the second commodity swap transaction (indicated at 134), which is between the municipal entity 102 and the commodity swap counterparty 128, the municipal entity 102 effectively agrees to pay to the commodity swap counterparty 128 an index price 136 for the gas and to be paid a fixed price 138 for the gas.

The municipal entity 102 may also enter into an interest rate swap transaction 140 with an interest rate swap counterparty 142 to hedge the interest rate risk assumed by the municipal entity 102 in issuing variable rate bonds. In the interest rate swap transaction 140, the municipal entity 102 effectively agrees to make payments at a fixed rate 144 to the interest rate swap counterparty 142 and to receive payment at a synthetic variable rate 146 from the interest rate swap counterparty 142.

In some embodiments, the synthetic variable rate 146 provided by the interest rate swap counterparty 142 may be derived from a London Interbank Offered Rate (LIBOR). For example, the synthetic rate may be defined as:

When the 1 month LIBOR is 1.00% or less, equal to the 1 month LIBOR;

when the 1 month LIBOR is between 1.00% and 4.89%, equal to 0.56 times the 1 month LIBOR plus 44 basis points; and

when the 1 month LIBOR is 4.89% or higher, equal to 0.65 times the 1 month LIBOR.

With a synthetic rate defined in this manner, the municipal entity 102 would receive a higher percentage of LIBOR when interest rates are relatively low. Consequently, this type of synthetic rate provides the municipal entity 102 with hedging against rate compression. (By “rate compression” is meant a reduction in the spread between tax-exempt and taxable returns.)

Also indicated in FIG. 1 are utility customers 148 of the municipal entity 102. The customers 148 receive natural gas deliveries 150 (in this example) and make payments 152 to municipal entity 102 that vary with the market price of gas.

In some embodiments, the supplier 122 may be the holder of equity in the special purpose entity 110 for tax purposes (via, e.g., the above-mentioned conditional finding agreement). In some embodiments, the supplier 122 may be affiliated with an investment bank (not separately indicated) which underwrites issuance of the tax-exempt bonds issued by the municipal entity 102. In some embodiments, the supplier 122 may not be the equity owner of the special purpose entity 110, which rather may be owned for tax purposes by the underwriting investment bank. In some embodiments, the supplier 122 may be unaffiliated with the underwriting investment bank. In some embodiments, the interest rate swap counterparty 142 may be, or may be an affiliate of, the underwriting investment bank.

In some embodiments, terms of the interest rate swap transaction 140 may call for automatic termination, without any mark-to-market settlement payment, of the interest rate swap transaction 140 upon occurrence of any one of a number of “automatic termination events”. Such automatic termination events may be defined to include (a) termination of the prepaid energy delivery contract between the municipal entity 102 and the special purpose entity 110 due to default by the special purpose entity 110; (b) reduction in the credit rating of the interest rate swap counterparty 142 below a specified level or levels; (c) bankruptcy or insolvency of the interest rate swap counterparty 142. Similar automatic termination events may apply to extinguish, without any mark-to-market settlement payment, the commodity swap transactions 130, 134.

In addition or alternatively, in some embodiments, the special purpose entity 110 may be obligated, at the option of the municipal entity 102, to remarket (instead of delivery to the municipal entity 102) for the account of the municipal entity 102 at least a portion of the gas supply, in the manner and to the extent permitted under applicable tax regulations.

In some embodiments, the bonds issued by the municipal entity 102 may pay a fixed interest rate rather than a variable rate. In some embodiments, the interest rate swap 140 may be dispensed with. In some embodiments, the interest on the bonds may be taxable rather than tax-exempt. In some embodiments, the funding for the prepayment 112 by the municipal entity 102 may become available other than via a bond issue.

In some embodiments, the “fixed for floating” interest rate swap 140 may feature a variable rate directly tied to an index (e.g., a straight percentage of LIBOR) rather than a synthetic variable rate. Alternatively, a synthetic variable rate other than the synthetic rate described above may be employed.

In some embodiments, the gas supply arrangement between the special purpose entity 110 and the supplier 122 may call for payment by the special purpose entity 110 of a fixed price for the natural gas rather than a variable price. In some embodiments, one or both of the commodity swaps 130, 134 may be dispensed with. In some embodiments, the swap transaction 134 may remain in place and the swap transaction 130 may be entered into by the supplier 122 rather than by the special purpose entity 110.

The financing techniques described above may be applied to prepayment of long-term electricity supply contracts in addition to or instead of financing gas supply contracts.

For accounting purposes, the special purpose entity 110 may be consolidated with the municipal entity 102 pursuant to relevant guidelines of the GASB (Government Accounting Standards Board) and would not be consolidated with its tax owner.

The above financing structure allows for market arbitrage that accrues to the benefit of the municipal entity 102. Further, the risk to the municipal entity 102 of failure of the supplier 122 is mitigated by the presence of the special purpose entity 110, which is backed up by the guaranteed investment contract. In the event of failure of the supplier 122, the continuing funding flow from the guaranteed investment contract allows the supplier to be replaced and will fund a replacement supply agreement with the new supplier.

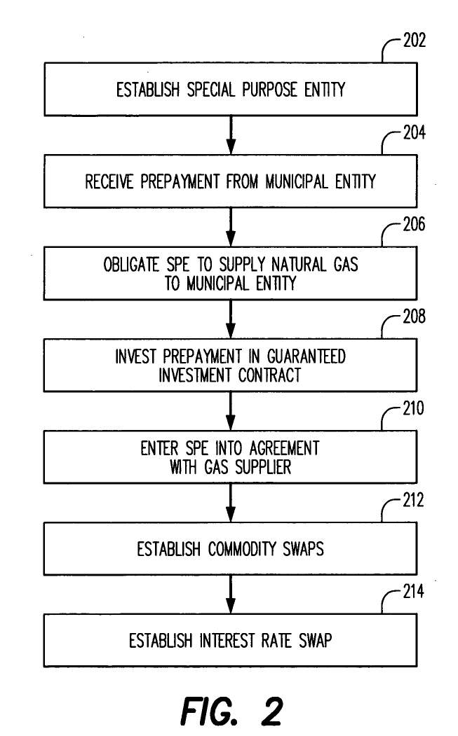

FIG. 2 is a flow chart that illustrates a process that may be performed in accordance with the financing technique of FIG. 1.

At 202 in FIG. 2, the special purpose entity 110 is established. At 204, the special purpose entity 110 receives the prepayment 112 from the municipal entity 102. At 206, the special purpose entity 110 undertakes a contractual obligation 114 to supply natural gas to the municipal entity 102. At 208, the special purpose entity 110 invests the prepayment in a guaranteed investment contract issued by the insurance company 118. At 210, the special purpose entity 110 enters into a gas supply agreement with the supplier 122. At 212, the commodity swap transactions 130, 134 are established. At 214, the interest rate swap 140 is established.

FIG. 2 and the above description thereof are not meant to imply a fixed order of steps. Rather, the steps may be performed in any order that is practicable. At least some of the steps may be performed simultaneously with one or more of the other steps illustrated in FIG. 2. For example, most if not all of the steps illustrated in FIG. 2 may be accomplished substantially simultaneously at a closing for the financing transaction.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method comprising:
establishing a special purpose entity in which a first party has made an equity investment;
establishing a first sales agreement between the special purpose entity and a second party, said first sales agreement for the special purpose entity to supply a physical commodity to the second party;
applying a prepayment amount received under the first sales agreement to acquire a guaranteed investment contract from an insurance company; and
establishing a second sales agreement between the special purpose entity and a supplier, said second sales agreement for the supplier to supply the physical commodity to the special purpose entity.

2. The method of claim 1, wherein the second party issues bonds that have a maturity that corresponds to the duration of said first sales agreement.

3. The method of claim 2, wherein the second party is a municipal entity and the bonds are tax exempt.

4. The method of claim 3, wherein:
the bonds pay interest at a variable rate; and
the second party enters into an interest rate swap transaction to pay a fixed rate and to receive a variable rate payment.

5. The method of claim 1, further comprising:
establishing a first commodity swap transaction between the special purpose entity and a third party, said first commodity swap transaction for the special purpose entity to pay to the third party a fixed price for said physical commodity and for the special purpose entity to receive from the third party an index price for said physical commodity;
and wherein said second party enters into a second commodity swap transaction with the third party, said second commodity swap transaction for the third party to pay to the second party said fixed price for said physical commodity and for said second party to pay to said third party said index price for said physical commodity.

6. The method of claim 1, wherein the first party is the supplier.

7. The method of claim 1, wherein the equity investment is a contingent investment.

8. The method of claim 1, wherein the physical commodity is natural gas.

9. The method of claim 1, wherein the physical commodity is electricity.

10. A method of achieving market-rate arbitrage with reduced exposure to credit risks, the method comprising:
a municipal entity issuing tax-exempt bonds to fund a prepayment, said bonds having a maturity period;
transferring the prepayment to a special purpose entity in return for the special purpose entity's obligation to provide natural gas or electricity to the municipal entity over a fixed term that matches said maturity period of said bonds;
said special purpose entity using the prepayment to obtain a guaranteed investment contract from an insurance company, said guaranteed investment contract having a contract term that matches said fixed term, said guaranteed investment contract providing a fixed return funding flow to said special purpose entity during said contract term; and
said special purpose entity entering into a supply agreement with a supplier to make periodic payments to said supplier in return for said supplier supplying fixed quantities of natural gas or electricity to said special purpose entity during a supply agreement term that matches said contract term.

11. The method of claim 10, further comprising:
establishing a first commodity swap transaction between the special purpose entity and a commodity swap counterparty, said first commodity swap transaction for the special purpose entity to pay to the commodity swap counterparty a fixed periodic payment and to receive from the commodity swap counterparty an index price for natural gas or electricity; and
establishing a second commodity swap transaction between the municipal entity and the commodity swap counterparty, said second commodity swap transaction for the commodity swap counterparty to pay to the municipal entity a fixed periodic payment and for the municipal entity to pay to the commodity swap counter-party an index price for natural gas or electricity.

12. The method of claim 11, further comprising:
establishing an interest rate swap transaction between the municipal entity and an interest rate swap counterparty for the municipal entity to pay a fixed periodic payment to the interest rate swap counterparty to make a variable-rate payment to the municipal entity.

13. The method of claim 12, wherein the variable-rate payment is based on a synthetic rate derived from a London Interbank Offered Rate (LIBOR).

14. The method of claim 10, wherein said supplier has an equity investment in said special purpose entity.

15. The method of claim 14, wherein said equity investment is in the form of a contingent funding agreement.

16. The method of claim 10, wherein a party which controls, is controlled by, or is under common control with said supplier has an equity investment in said special purpose entity.

17. A method comprising:
establishing a special purpose entity;
receiving a prepayment from a municipal entity;
obligating the special purpose entity to supply natural gas or electricity to the municipal entity;
investing the prepayment to obtain a fixed return; and
entering the special purpose entity into an agreement with a supplier to obtain a fixed supply of natural gas or electricity.

18. The method of claim 17, further comprising:
entering the special purpose entity into a commodity swap transaction to exchange a fixed payment for a payment indexed to a price of natural gas or electricity.

19. The method of claim 17, wherein an entity other than the municipal entity has an equity investment in the special purpose entity.

20. The method of claim 17, wherein the prepayment is invested by the special purpose entity in a guaranteed investment contract from an insurance company.
